(19) United States
(12) Patent Application Publication
(10) Pub. No.: US 2021/0132474 A1
(43) Pub. Date: May 6, 2021

(54) Birdfeeder Camera Attachment

(71) Applicant: Maximilian Wolfgang Guettinger, Kennewick, WA (US)

(72) Inventor: Maximilian Wolfgang Guettinger, Kennewick, WA (US)

(73) Assignee: Maximilian Wolfgang Guettinger, Kennewick, WA (US)

(21) Appl. No.: 16/670,599

(22) Filed: Oct. 31, 2019

(51) Int. Cl. G03B 17/56; A01K 39/01; A01K 45/00

(52) U.S. Cl. CPC G03B 17/561; A01K 45/00; A01K 39/01

(57) ABSTRACT

The invention Birdfeeder Camera Attachment develops a portable way of attracting birds to a camera. Embodiments of the invention consist of a tripod mount with a bowl or tray for feeding birds which has its own camera mount attached to it as well as possible counterweights. The invention acts as a field portable birdfeeder with camera mounts attached that can be set up on conventional camera tripods.

### BACKGROUND OF THE INVENTION

Photographing birds quite often requires having a camera mounted near a food source. Past attempts to reconcile this requirement have included creating specially mounted, fixed place structures such as birdfeeders attached to porches or fixed posts in lawns. The invention described herein presents a novel way of solving the problem of portability by providing an alternative which can be set up in the field on a tripod or other such structure and can even be stowed away relatively easily when not needed.

### SUMMARY OF THE INVENTION

The invention is described as a tripod mountable birdfeeder. Able to fit on standard camera tripods it is field portable and offers a wide range of functionalities depending on design. The simplest embodiment of this invention is one where a modular system of parts that screw into one another produces a bird feeding bowl which attaches to a tripod or other mount and has its own elevated threaded mount in its center for mounting cameras. In particular this embodiment would allow for the easy mount of cameras with a 360 degree field of vision for producing virtual reality videos and pictures of avians. Other embodiments of the invention modify this design to include a centrally mounted camera mount pedestal with a food tray projecting from it and a counterweight system in its rear for taking narrower shots. A system in which a centralized feeding bowl and lateral camera mount and opposing counterweight would allow for an alternative means of photographing birds.

### BRIEF DESCRIPTIONS OF DRAWINGS

FIG. 1 describes a top angled front view of the invention showing an embodiment where a three-part modular system is assembled to provide a tripod mount, a feeder bowl, and a camera mount.

FIG. 2 describes a cross sectional view of FIG. 1 as viewed from the side showing the bowl, camera mount pedestal, and tripod mount.

FIG. 3 describes a view of FIG. 1's invention embodiment as it would appear disassembled for transport having the tripod mount, camera mount, and feeder bowl separated.

FIG. 4 describes a cross section of FIG. 3 with the unassembled parts being shown.

FIG. 5 describes a bottom view of the unassembled embodiment of the invention in FIG. 3.

FIG. 6 describes a second embodiment of the invention looking at an angle showing a system that utilizes a tray with an opposing counterweight attached to the central camera mount.

FIG. 7 is a top down view of the second embodiment shown in FIG. 6.

FIG. 8 is a cross sectional view of the second embodiment described in FIG. 6.

FIG. 9 shows a third embodiment of the invention with a centrally mounted feeding bowl that has lateral camera mount and counterweight arms at opposing ends, all attached to a central tripod mount.

FIG. 10 describes a top view of the third invention embodiment shown in FIG. 9 detailing that the feeder bowl in this embodiment has faceted sides.

FIG. 11 describes a cross sectional view of the third embodiment of the invention shown in FIG. 9.

### DETAILED DESCRIPTION OF INVENTION

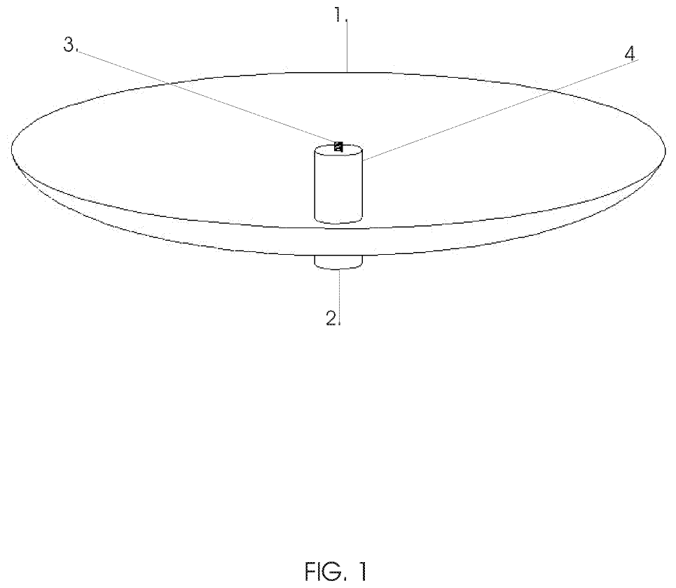

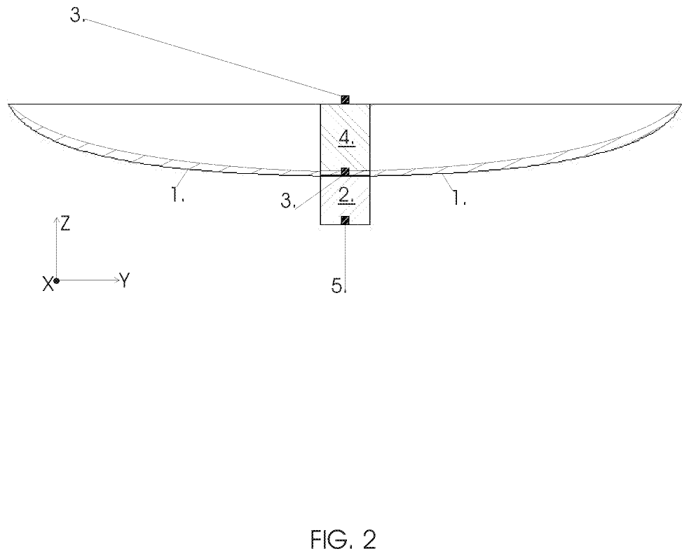

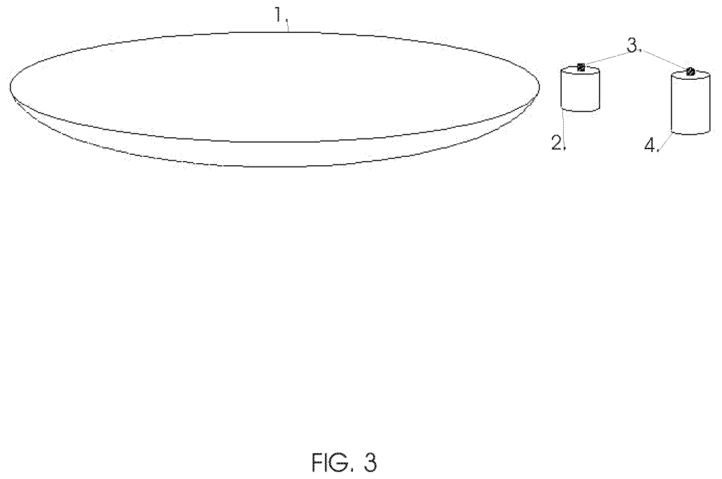

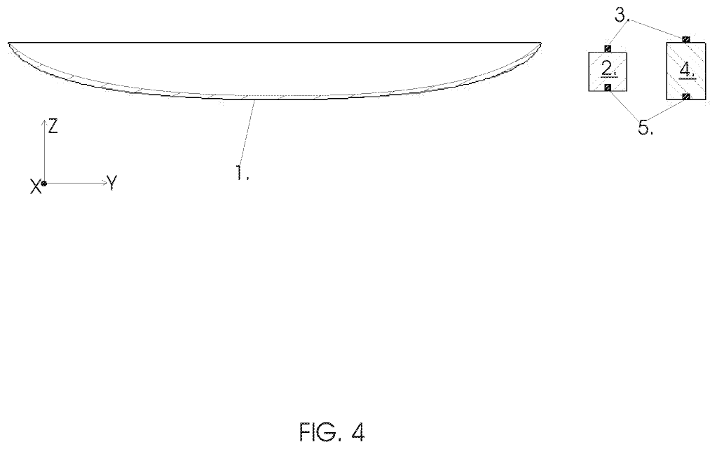

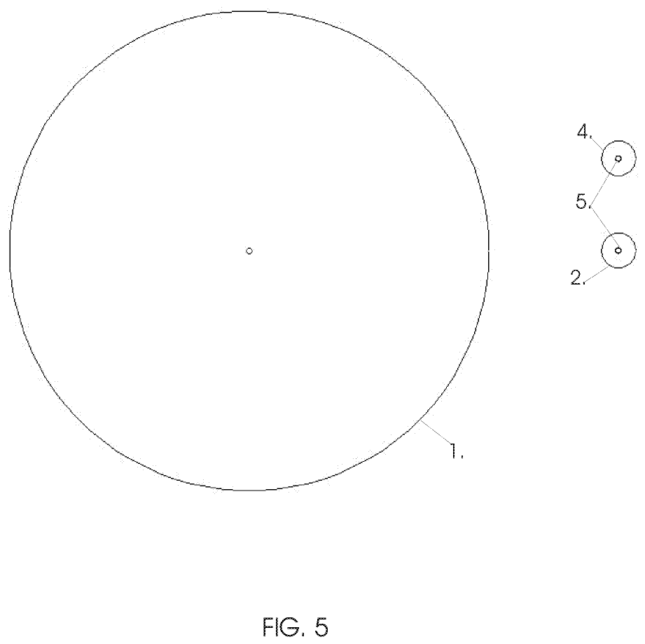

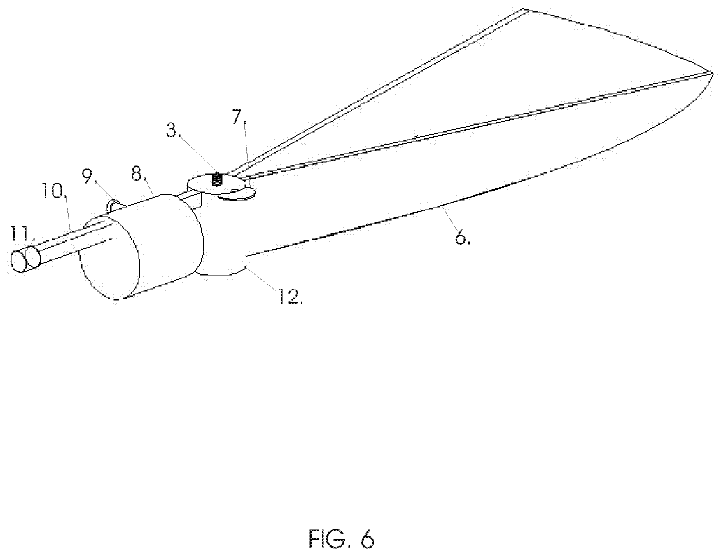

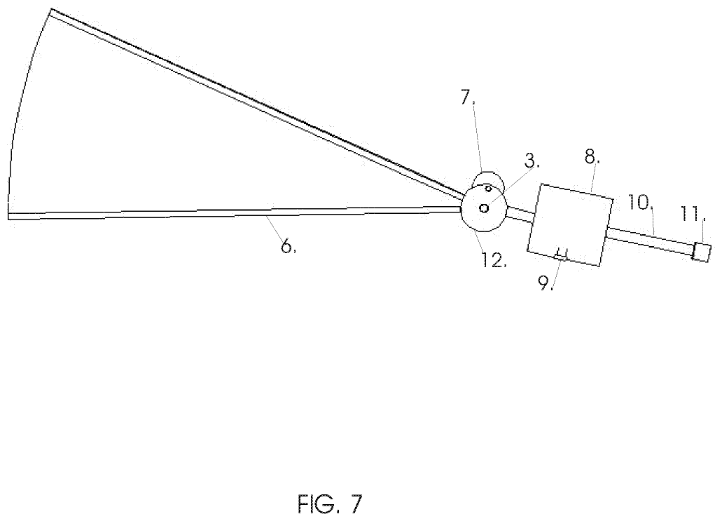

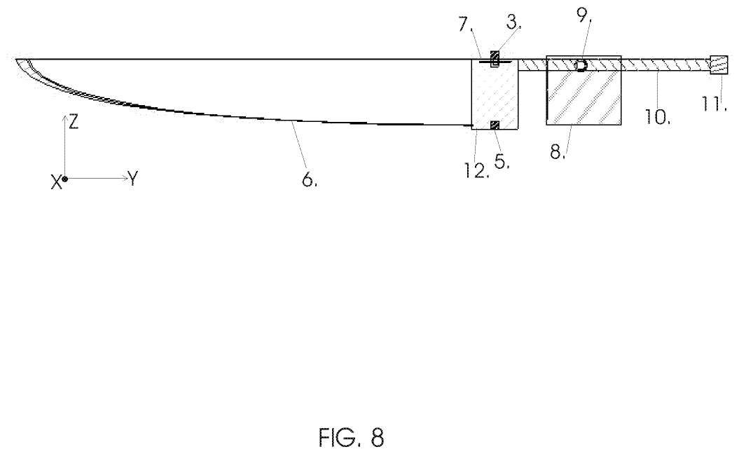

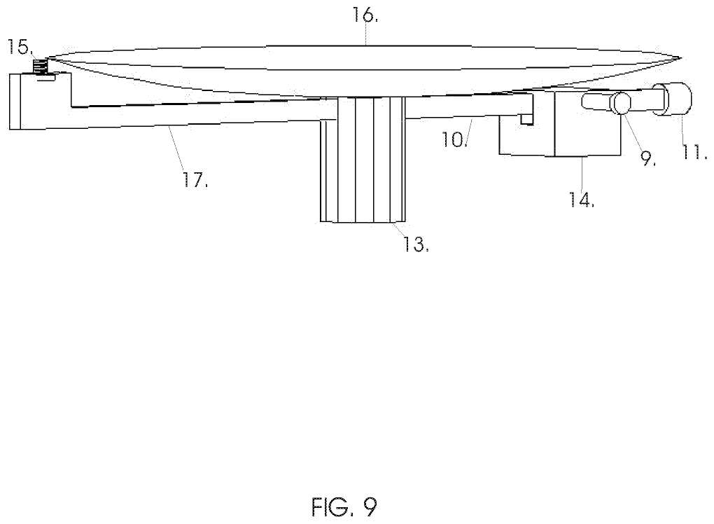

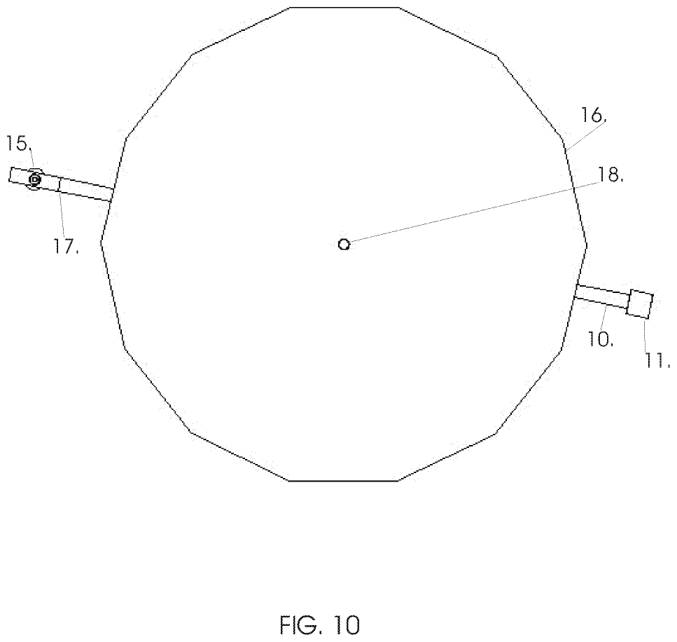

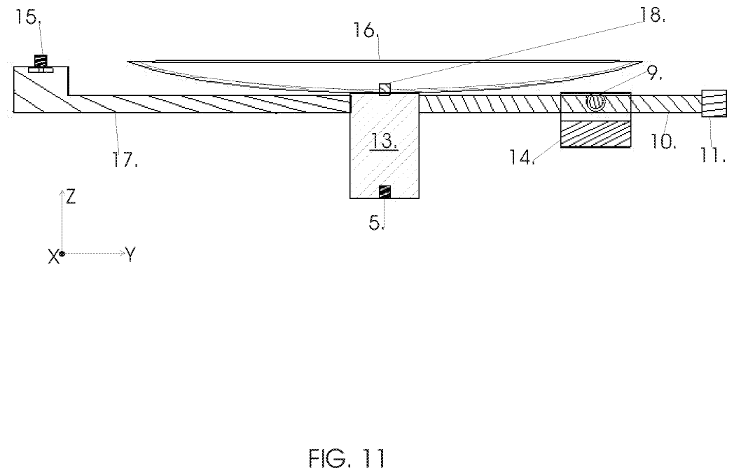

The illustrated drawings shown in the following describe preferred embodiments of the invention but are not intended to limit its present scope or forms. In reference to FIG. 1 we see a preferred embodiment of the invention with 1 being the feeder bowl that can contain bird feed. This is screwed into two other modular parts to form the invention with 2 being the mount to which the invention is attached to a tripod via a screw and 4 being a raised camera mount pedestal which serves to elevate the users camera above the bird feed in the bowl. The raised camera mount pedestal 4 sports a top threaded screw 3 for attaching a camera to the assembly. FIG. 2 is a cross section of FIG. 1 in which the assembly of this preferred embodiment of the invention can be seen. The threaded screw system 3 allows for the parts 2 and 4 to be attached to one another with the bowl 1 to be set in between thus creating a tripod mountable bird feeding camera attachment. FIG. 3 is a top angled view of the FIG. 1's invention embodiment disassembled, showing the bowl 1, the tripod mount 2, and the camera mount 4 with their associated threaded screws 3. The threaded screws 3 may all be the standard size for camera mounts. FIG. 4 details a cross sectional view of the invention embodiment in FIG. 3 with the bowl 1, the tripod mount 2, the camera mount 4, and the threaded screws 3 and threaded holes 5 shown. FIG. 5 is a bottom view of the invention embodiment in FIG. 3 showing the bowl's 1 pass through hole as well as the bottoms of the tripod mount 2 and camera mount 4 with their holes threaded 5 to accept the threaded screws 3. FIG. 6 details a second preferred embodiment of the invention where a central mounting pillar 12, that is bottom threaded so as to attach to a tripod and top fitted with a screw 3 and geared tightening mechanism 7 to attach to a camera, is attached to a tray for bird feed 6 on one side and a counterweight system on the other. The counterweight system consists of a horizontal rail 10 with an end stop 11 that sports a sliding counterweight 8 which can be tightened down using a tightening knob 9. The purpose of this second embodiment is to allow for a centrally mounted camera to face a lateral bird feeding tray that is counterbalanced by an opposite sliding weight. FIG. 7 is a top down view of this second embodiment of the invention. FIG. 8 is a cross sectional view of the second embodiment of the invention where can be seen the curved nature of the tray 6 as well as the nature of the sliding counterweight 8 and the bottom threaded hole 5. The geared tightening mechanism 7 is a simple wheel which the user can rotate to turn the central screw 3 for tightening the camera to a precise angle. FIG. 9 shows a third preferred embodiment of the invention where a central tripod mount 13 is attached to a faceted bowl 16 along with a counterweight arm on one side and a camera mounting arm on the other. The camera mounting arm 17 has a raised portion which allows for the camera to be attached level with the feeding bowl 16. There is a tightening screw with a thumb wheel 15 mounted on the raised section of the camera mounting arm 17 for attaching the camera. On the opposite side of the tripod mount from the camera arm there is a counterweight rail 10 which ports a rectangular sliding counterweight 14 and an end stop 11. The rectangular counterweight 14 sports a tightening knob 9. FIG. 10 shows a top view of the third invention embodiment demonstrating the faceted nature of the bowl 16 and a top attachment knob 18 which attaches the bowl to the main body. FIG. 11 shows the relations of the assembled parts of the third preferred embodiment of the invention as well as the threaded hole 5 for mounting onto a tripod.

1. The invention consists of bird feeding camera attachment that can be mounted to a tripod.

2. The invention may be modular in design and allow for multiple varieties of camera systems to be used.
